(19) United States
(12) Patent Application Publication
(10) Pub. No.: US 2007/0139246 A1
(43) Pub. Date: Jun. 21, 2007

(54) Remote-controllable dashboard

(76) Inventor: Shih-Ling Chen, Sinjhuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/305,238

(22) Filed: Dec. 19, 2005

(51) Int. Cl. G08C 19/12

(52) U.S. Cl. 341/176; 340/825.69; 340/870.02

(57) ABSTRACT

A remote-controllable meter/gauge dashboard includes a plurality of meters/gauges, each having an indication surface having a digital display or a pointer-based dial, a receiver arranged inside each meter/gauge, an indicator mounted on the indication surface. Each meter/gauge has a setting-adjustable parameter. A remote controller includes a keyboard module having a plurality of user-actuateable control keys associated with the meters/gauges respectively and generating control signals for the associated meters/gauges, and a transmitter that transmits the control signals to the receivers of the meters/gauges to wirelessly and operatively couple the remote controller to the meters/gauges. Actuation of each control key issues the associated control signal to the associated meter/gauge, which initiates the meter/gauge to carry out adjustment of the parameter. Thus, settings of the meters/gauges can be done in a wireless manner. Displaying color of each meter/gauge can also be changed with the remote controller.

### BACKGROUND OF THE INVENTION

1. Field of the Invention

The present invention generally relates to remote-controllable meters/gauges, and in particular to a remote-controllable automobile dashboard that allows for adjustment/control of individual meters/gauges of the automobile dashboard and change of displaying color of the individual meter/gauge with a remote controller.

2. The Related Art

A variety of dashboards are available for automobiles. Although the dashboards may demonstrate different functions, they can be classified as setting-adjustable ones and setting-fixed ones. The setting-fixed meters/gauges are devices that have fixed settings defined by the manufacturers and general consumers are not allowed to change or adjust the settings or internal functions of the meters/gauges by themselves. On the other hand, the setting-adjustable meters/gauges provides the general consumers with adjustability of the settings or internal functions of the meters/gauges. In other words, the user of the meters/gauges can change the settings or internal functions of the meters/gauges to suit the particular needs of his or her automobile.

The conventional setting-adjustable meters/gauges are knob-based devices and the user must physically engage the knob or push button for adjustment of the meter/gauge. This causes trouble to the drivers in some cases. For example, for a racer car, some meters/gauges are arranged on the facial board or the A-pillar of the car. This makes the meters/gauges distant from the driver whereby the driver must far reach his or her hand out for operating the meters/gauges. Furthermore, using hands to directly operate the knob often prevents the driver or user to clearly watch out the adjustment operation for the eyesight of the driver may be shielded by his or her operating the knob.

Remote-controllable meters/gauges are available in the market. However, these known remote-controllable meters/gauges are wire-controlled, which is disadvantageous in the limitation imposed by the length of the wire. Further, the storage of the wire, when not in use, also causes problems in certain applications.

Thus, the present invention is aimed to resolve the troubles of the conventional meters/gauges by providing a remote-controllable dashboard that allows for easy and efficient adjustment of meters/gauges thereof.

### SUMMARY OF THE INVENTION

An objective of the present invention is to provide a remote-controllable dashboard, particularly suitable for vehicles, which allows for adjustment/setting of meters/gauges in an easy and efficient manner, even within a very limited space inside a vehicle and also allowing for adjustment performed at any location inside the vehicle, including the backseat.

To achieve the above objective, the present invention provides a remote-controllable meter/gauge arrangement, comprising at least one meter/gauge comprising an indication surface having a digital display and/or a pointer-based dial, a receiver arranged inside the meter/gauge, an indicator mounted on the indication surface, the meter/gauge having a setting-adjustable parameter, and a remote controller comprising a keyboard module comprising at least one user-actuateable control key associated with each meter/gauge and generating a control signal for the meter/gauge, and a transmitter that transmits the control signal to the receiver of the meter/gauge to wirelessly and operatively couple the remote controller to the meter/gauge, wherein actuation of the control key issues the control signal to the meter/gauge, which initiates the meter/gauge to carry out adjustment of the parameter.

In accordance with the present invention, a displaying color of the meter/gauge can also be changed with the remote controller.

In an embodiment of the present invention, the meter/gauge is adapted to mount inside a vehicle, such as an automobile, having an electrical system. The meter/gauge is electrically connected to the electrical system to receive an operation power from the electrical system.

In an embodiment of the present invention, the remote-controller is powered by a built-in power source, such as a replaceable battery or a rechargeable cell.

In a preferred embodiment of the present invention, the remote-controllable meter/gauge arrangement comprises a voltmeter, a water temperature gauge, an oil temperature gauge, an oil pressure gauge, a turbo gauge, a vacuum gauge, and an odometer and the keyboard module of the remote-controller comprises a voltmeter control key, a water temperature gauge control key, an oil temperature gauge control key, an oil pressure control key gauge, a turbo gauge control key, a vacuum gauge control key, and an odometer control key, respectively corresponding to the voltmeter, the water temperature gauge, the oil temperature gauge, the oil pressure gauge, the turbo gauge, the vacuum gauge, and the odometer and further comprising a down-shifting key, an up-shifting key, and a function setting key.

In an embodiment of the present invention, the keyboard module of the remote-controller comprises a color selection key.

In an embodiment of the present invention, the keyboard module of the remote-controller comprises a fan control key.

In an embodiment of the present invention, the indicator comprises a light-emitting diode based device.

In embodiment of the present invention, the control signal is an electromagnetic signal, such as a radio frequency signal and an infrared beam.

### BRIEF DESCRIPTION OF THE DRAWINGS

The present invention will be apparent to those skilled in the art by reading the following description of a preferred embodiment thereof, with reference to the attached drawings, in which:

FIG. 1 is a schematic plan view of a remote-controlled dashboard constructed in accordance with the present invention;

FIG. 2 is schematic plan view of a remote controller in accordance with the present invention; and

FIG. 3 is a symbolized representation of a keyboard of the remote controller of the present invention.

### DETAILED DESCRIPTION OF THE PREFERRED EMBODIMENT

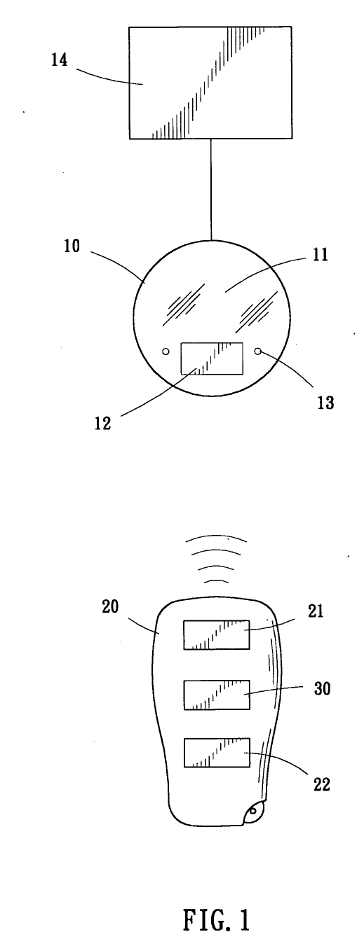

With reference to the drawings and in particular to FIG. 1, a remote-controllable dashboard constructed in accordance with the present invention comprises at least one meter/gauge 10 and a remote-controller 20. The meter/gauge 10 is mounted on for example an automobile (not shown) and has an indication surface 11, which can be a digital display or a pointer-based dial face, a wireless signal receiver 12 arranged inside the meter/gauge 10, and at least one light-emitting diode 13 mounted on the indication surface 11. The meter/gauge 10 is connected to a power source 14 of an electrical system of the automobile, which supplies an operation power to the meter/gauge 10.

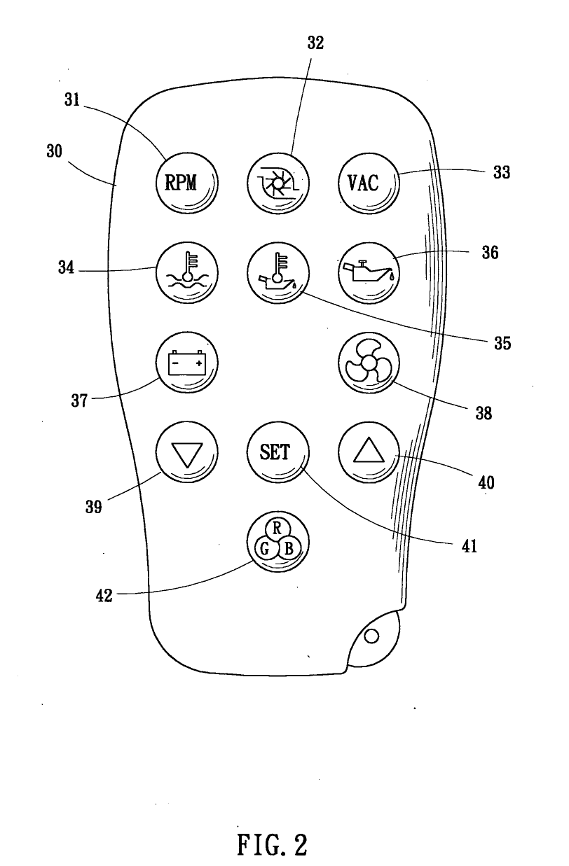

Also referring to FIG. 2, the remote-controller 20 comprises a wireless signal transmitter 21 arranged inside the remote-controller 20, a keyboard module 30, and a replaceable battery or cell 22. Alternatively, the replaceable battery 22 can be substituted by a rechargeable cell or other built-in power sources.

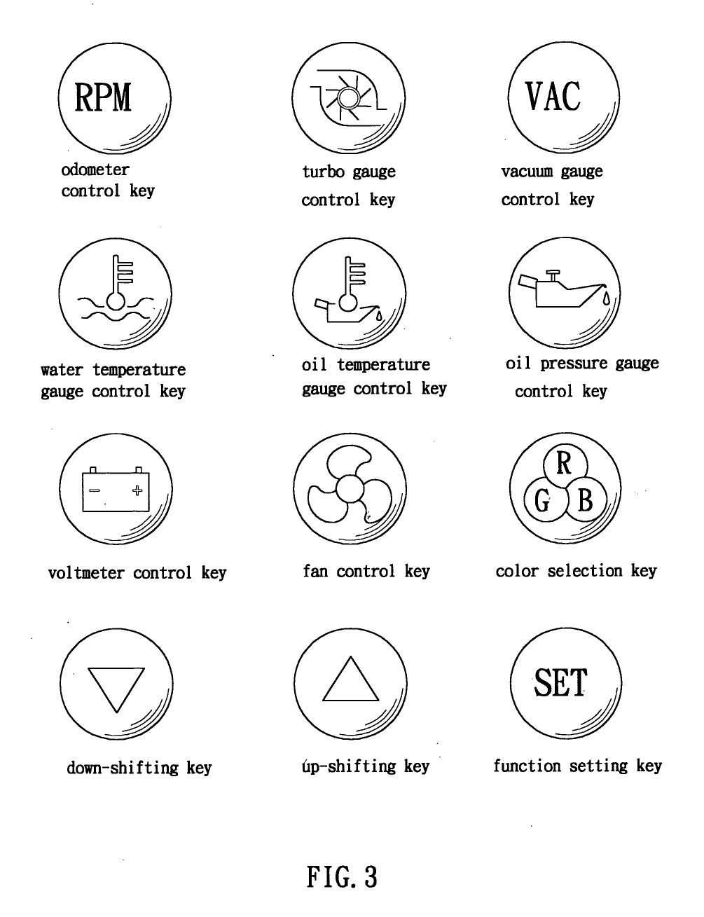

The keyboard module 30 comprises a plurality of keys or pushbuttons, including a odometer control key 31, a turbo gauge control key 32, a vacuum gauge control key 33, a water temperature gauge control key 34, an oil temperature gauge control key 35, an oil pressure gauge control key 36, a voltmeter control key 37, a fan control key 38, a down-shifting key 39, an up-shifting key 40, a function setting key 41, and a color selection key 42. FIG. 3 shows a symbolized arrangement of the keys 31-42 of the keyboard module 30 in accordance with an embodiment of the present invention.

In practical applications, the remote-controller 20 is powered by the replaceable battery 22 arranged inside the remote-controller 20 to provide wireless control signals that are generated by the actuation of one or more keys 31-42 of the keyboard module 30 or combinations thereof. An example of the control signal includes an electromagnetic signal, such as a radio frequency signal and an infrared beam, but not limited thereto. The control signals are transmitted through the transmitter 20 to the receiver 12 of the meter/gauge 10 and, upon receipt of the control signals, the meter/gauge 10 performs adjustment or control of the settings thereof. The result of adjustment is shown on the indication surface 11 of the meter/gauge 10.

Two examples will be given to demonstrate the operation of the present invention.

### EXAMPLE 1

### Adjustment/Control of Voltmeter (Including Auto Timer)

The example is applied to an automobile voltmeter. By actuating the voltmeter control key 37 of the remote-controller 10, the light-emitting diode 13 of the voltmeter on the automobile, which in this example, is represented by the meter/gauge 10 shown in FIG. 1, blinks green light, indicating that the voltmeter is connected, through the signals transmitted between the transmitter 21 and the receiver 12, to the remote-controller 10, and the voltmeter is ready for adjustment. The down-shifting key 39 and up-shifting key 40 of the remote-controller 10 are then used to adjust the threshold setting or warning level setting of the voltmeter.

If, at this time, the color selection key 42 is depressed, the displaying color of the voltmeter can be selected and changed.

With the voltmeter in the condition of setting operation, actuating the fan control key 38 initiates a setting process for auto timer of the automobile. At this time, the light-emitting diode 13 blinks orange light to indicate the setting operation of the auto timer. If no other setting is to be done subsequently, then the function setting key 41 can be actuated to cause the voltmeter to memorize the settings that were just done and will apply these settings in subsequent operations of the voltmeter.

### EXAMPLE 2

### Adjustment/Control of Water Temperature Gauge/Oil Temperature Gauge (Including Fan Control)

The example is applied to a water temperature gauge/oil temperature gauge of an automobile. By actuating the water temperature gauge control key 34 (or oil temperature gauge control key 35), the light-emitting diode 13 of the water temperature gauge (or oil temperature gauge) of the automobile, which in this example, is represented by the meter/gauge 10 shown in FIG. 1, blinks green light, indicating that the water temperature gauge is connected, through the signals transmitted between the transmitter 21 and the receiver 12, to the remote-controller 10, and the water temperature gauge (or the oil temperature gauge) is ready for adjustment. The down-shifting key 39 and up-shifting key 40 of the remote-controller 10 are then used to adjust the threshold setting or warning level setting of the water temperature gauge (or the oil temperature gauge).

Similar to the previous example, actuation of the color selection key 42 allows for selection and change of the displaying color of the water temperature gauge or the oil temperature gauge.

With the water temperature gauge (or the oil temperature gauge) in the condition of setting operation, actuating the fan control key 38 initiates a control function setting process for the automobile fan and the light-emitting diode 13 blinks orange light to indicate the adjustment/control of the automobile fan. By actuating the down-shifting key 39 and the up-shifting key 40, settings of the automobile fan can be done. If no other setting is to be done, then the function setting key 41 can be actuated to cause the voltmeter to memorize the settings that were just done and will apply these settings in subsequent operation of the water temperature gauge (or the oil temperature gauge) and the fan.

Apparently, a user can set the meters/gauges according to the desired performance and operation of each individual meter/gauge, the operation condition of the automobile, and the condition of the automobile itself. Due to the employment of the electromagnetic signal to operatively couple the dashboard with the remote controller, the adjustment of each individual meter/gauge can be performed at any location inside the automobile, including the backseat. No physical limitation is imposed on the adjusting operation, which effectively improve the operation efficiency of the adjustment of the dashboard.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A remote-controllable meter/gauge arrangement, comprising:
at least one meter/gauge comprising an indication surface having a digital display and/or a pointer-based dial, a receiver arranged inside the meter/gauge, an indicator mounted on the indication surface, the meter/gauge having a setting-adjustable parameter; and
a remote controller comprising a keyboard module comprising at least one user-actuateable control key associated with each meter/gauge and generating a control signal for the meter/gauge, and a transmitter that transmits the control signal to the receiver of the meter/gauge to wirelessly and operatively couple the remote controller to the meter/gauge;
wherein actuation of the control key issues the control signal to the meter/gauge, which initiates the meter/gauge to carry out adjustment of the parameter.

2. The remote-controllable meter/gauge arrangement as claimed in claim 1, wherein the parameter comprises displaying color of the meter/gauge.

3. The remote-controllable meter/gauge arrangement as claimed in claim 1, wherein the meter/gauge is adapted to mount inside a vehicle having an electrical system and wherein the meter/gauge is electrically connected to the electrical system to receive an operation power from the electrical system.

4. The remote-controllable meter/gauge arrangement as claimed in claim 1, wherein the remote-controller comprises a built-in power source.

5. The remote-controllable meter/gauge arrangement as claimed in claim 4, wherein the built-in power source comprises a replaceable battery.

6. The remote-controllable meter/gauge arrangement as claimed in claim 1 comprising a voltmeter, a water temperature gauge, an oil temperature gauge, an oil pressure gauge, a turbo gauge, a vacuum gauge, and an odometer.

7. The remote-controllable meter/gauge arrangement as claimed in claim 6, wherein the keyboard module of the remote-controller comprises a voltmeter control key, a water temperature gauge control key, an oil temperature gauge control key, an oil pressure control key gauge, a turbo gauge control key, a vacuum gauge control key, and an odometer control key, respectively corresponding to the voltmeter, the water temperature gauge, the oil temperature gauge, the oil pressure gauge, the turbo gauge, the vacuum gauge, and the odometer and further comprising a down-shifting key, an up-shifting key, and a function setting key.

8. The remote-controllable meter/gauge arrangement as claimed in claim 2, wherein the keyboard module of the remote-controller comprises a color selection key.

9. The remote-controllable meter/gauge arrangement as claimed in claim 3, wherein the keyboard module of the remote-controller comprises a fan control key.

10. The remote-controllable meter/gauge arrangement as claimed in claim 1, wherein the indicator comprises a light-emitting diode based device.

11. The remote-controllable meter/gauge arrangement as claimed in claim 1, wherein the control signal comprises an electromagnetic signal.
